(19) United States
(12) Patent Application Publication
(10) Pub. No.: US 2011/0257057 A1
(43) Pub. Date: Oct. 20, 2011

(54) CLEANING SOLUTION FOR STAINLESS STEEL AND CLEANING METHOD USING SAME

(75) Inventors: WEI HUANG, Shenzhen City (CN); LING-QIAN CAI, Shenzhen City (CN)

(73) Assignees: FIH (HONG KONG) LIMITED, Kowloon (HK); SHENZHEN FUTAIHONG PRECISION INDUSTRY CO., LTD., ShenZhen City (CN)

(21) Appl. No.: 12/974,115

(22) Filed: Dec. 21, 2010

(30) Foreign Application Priority Data
Apr. 20, 2010 (CN) 201010151259.8

(51) Int. Cl. C23G 1/08; C11D 3/60

(52) U.S. Cl. 510/269

(57) ABSTRACT

A cleaning solution for cleaning stainless steels etched by ferric or ferrous salt solution is provided. The cleaning solution including: one or more ingredients selected from a group consisting of inorganic acid, inorganic alkali metal salt, and inorganic alkaline-earth metal salt in a concentration of about 200-600 g/L; complexant being capable of complexing with ferric or ferrous ions in a concentration of about 26-275 g/L; and one of carboxylic acid and carboxylate, or a combination thereof, in a concentration of about 75-250 g/L. A method for cleaning the stainless steels is also described there.

### BACKGROUND

1. Technical Field

The present disclosure relates to a solution and method for cleaning stainless steel.

2. Description of Related Art

Stainless steel housings of electronic devices are often chemically etched to form decorative patterns. Etching solutions used may be ferric or ferrous salt solutions. However, the ferric or ferrous ions contained in the solution are prone to attach to the etched surface and are difficult to be cleaned away using water.

Therefore, there is room for improvement within the art.

### DETAILED DESCRIPTION

The present disclosure relates to a cleaning solution and a related method for cleaning stainless steel. The stainless steel may be used to make housings of electronic devices. The stainless steel is partially etched by ferric or ferrous salt solution to form decorative patterns. Partial ferric or ferrous ions contained in the etched solution are still attached to the etched portion of the stainless steel after a rinsing of water.

The cleaning solution may be an aqueous solution containing: one or more ingredients selected from a group consisting of inorganic acid, inorganic alkali metal salt, and inorganic alkaline-earth metal salt; complexant capable of complexing with ferric or ferrous ions; one of carboxylic acid and carboxylate, or a combination thereof; and inorganic oxidizing acid.

The inorganic acid may be phosphoric acid or sulphuric acid. The phosphoric acid may be an aqueous solution that is 85% H₃PO₄ by mass percentage. The sulphuric acid may be an aqueous solution that is 98% H₂SO₄ by mass percentage.

The inorganic alkali metal salt may be sodium phosphate or sodium sulfate.

The inorganic alkaline-earth metal salt may be magnesium phosphate or calcium sulfate.

The inorganic acid, inorganic alkali metal salt, inorganic alkaline-earth metal salt, or a combination thereof may have a concentration of about 200-600 g/L in the cleaning solution, and in this exemplary embodiment is about 300-350 g/L. The inorganic acid, inorganic alkali metal salt, inorganic alkaline-earth metal salt, or a combination thereof providing the cleaning solution H⁺ and an acidic condition to prevent the ferric or ferrous ions attached on the stainless steel from hydrolyzing and depositing on the stainless steel.

The complexant may be one or more ingredients selected from a group consisting of disodium edentate dehydrate, tetrasodium salt dihydrate, etidronic acid, citric acid, sodium citrate, tartaric acid, sodium potassium tartrate, and sodium gluconate. The concentration of the complexant may be about 26-275 g/L, and in this exemplary embodiment is about 125-175 g/L. The complexant reacts with the ferric or ferrous ions attached on the stainless steel and speeds dissolution of the ferric or ferrous ions into the cleaning solution.

The carboxylic acid may be acetic acid or benzoic acid. The acetic acid may be an aqueous solution of 36% mass percentage C₂H₂O₄.

The carboxylate may be sodium acetate or sodium benzoate.

The carboxylic acid, carboxylate, or a combination thereof may have a concentration of about 75-250 g/L, and in this exemplary embodiment is about 150-200 g/L. The carboxylic acid, carboxylate, or a combination thereof is used as an inhibiter which can maintain the acidity of the cleaning solution during a cleaning process.

The inorganic oxidizing acid may be nitric acid. The nitric acid may be an aqueous solution of 68% mass percentage HNO₃. The nitric acid may have a concentration of about 75-150 g/L in the cleaning solution, and in this exemplary embodiment is 100-125 g/L.

The method for cleaning stainless steel may include steps of providing the cleaning solution, and contacting the stainless steel with the cleaning solution for about 15-120 seconds. The means of contacting may be immersing the stainless steel into the cleaning solution or spraying the stainless steel by the cleaning solution. After contacting, the stainless steel may be rinsed with water and dried. The ferric or ferrous ions attached can be effectively removed from the stainless steel by the method. Furthermore, the cleaning solution has a low corrosiveness, and the complexant can allow prolonged use of the cleaning solution without damage occuring.

### Examples

Experimental examples of the present disclosure follow:

### Example 1

1000 ml cleaning solution was provided. The cleaning solution consisted of phosphoric acid in a concentration of 600 g/L, nitric acid in a concentration of 150 g/L, sodium acetate in a concentration of 150 g/L, sodium potassium tartrate in a concentration of 75 g/L, etidronic acid in a concentration of 25 g/L, and deionized water.

Samples of stainless steel etched by ferric or ferrous salt solution were provided. The samples were completely immersed in the cleaning solution for about 15 seconds at room temperature. After this process, the samples were taken out of the cleaning solution and were dried after being rinsed with water.

### Example 2

1000 ml cleaning solution was provided. The cleaning solution consisted of phosphoric acid in a concentration of 200 g/L, nitric acid in a concentration of 100 g/L, disodium edetate dehydrate in a concentration of 40 g/L, citric acid in a concentration of 100 g/L, and deionized water.

Samples of stainless steel etched by ferric or ferrous salt solution were provided. The samples were completely immersed in the cleaning solution for about 60 seconds at room temperature. After this process, the samples were taken out of the cleaning solution and were dried after being rinsed with water.

### Example 3

1000 ml cleaning solution was provided. The cleaning solution consisted of sulphuric acid in a concentration of 400 g/L, nitric acid in a concentration of 75 g/L, benzoic acid in a concentration of 75 g/L, tetrasodium salt dihydrate in a concentration of 125 g/L, sodium potassium tartrate in a concentration of 80 g/L, and deionized water.

Samples of stainless steel etched by ferric or ferrous salt solution were provided. The samples were completely immersed in the cleaning solution for about 120 seconds at room temperature. After this process, the samples were taken out of the cleaning solution and were dried after being rinsed with water.

### Example 4

1000 ml cleaning solution was provided. The cleaning solution consisted of sodium sulfate in a concentration of 400 g/L, nitric acid in a concentration of 75 g/L, carboxylic acid in a concentration of 100 g/L, tetrasodium salt dihydrate in a concentration of 40 g/L, etidronic acid in a concentration of 35 g/L, and deionized water.

Samples of stainless steel etched by ferric salt solution were provided. The samples were completely immersed in the cleaning solution for about 90 seconds at room temperature. After this process, the samples were taken out of the cleaning solution and were dried after being rinsed with water.

### Results of the Examples 1-4

The samples processed in the examples 1-4 were inspected by optical microscope. No impurity was detected on the surfaces of the samples. Accordingly, the ferric or ferrous ions were effectively and completely removed from the stainless steels.

It is believed that the present embodiment and its advantages will be understood from the foregoing description, and it will be apparent that various changes may be made thereto without departing from the spirit and scope of the disclosure or sacrificing all of its advantages, the examples hereinbefore described merely being preferred or exemplary embodiment of the disclosure.

What is claimed is:

1. A cleaning solution for stainless steel, comprising:
one or more ingredients selecting from a group consisting of inorganic acid, inorganic alkali metal salt, and inorganic alkaline-earth metal salt in a concentration of about 200-600 g/L;
complexant being capable of complexing with ferric or ferrous ions in a concentration of about 26-275 g/L; and
one of carboxylic acid and carboxylate, or a combination thereof, in a concentration of about 75-250 g/L.

2. The cleaning solution as claimed in claim 1, wherein the inorganic acid is phosphoric acid or sulphuric acid.

3. The cleaning solution as claimed in claim 1, wherein the inorganic alkali metal salt is sodium phosphate or sodium sulfate.

4. The cleaning solution as claimed in claim 1, wherein the inorganic alkaline-earth metal salt is magnesium sulfate or calcium sulfate.

5. The cleaning solution as claimed in claim 1, wherein the inorganic acid, inorganic alkali metal salt, inorganic alkaline-earth metal salt, or a combination thereof has a concentration of about 300-350 g/L.

6. The cleaning solution as claimed in claim 1, wherein the complexant is one or more selected from a group consisting of disodium edentate dehydrate, tetrasodium salt dihydrate, etidronic acid, citric acid, sodium citrate, tartaric acid, sodium potassium tartrate, and sodium gluconate.

7. The cleaning solution as claimed in claim 6, wherein the complexant has a concentration of about 125-175 g/L.

8. The cleaning solution as claimed in claim 1, wherein the carboxylic acid is benzoic acid or carboxylic acid.

9. The cleaning solution as claimed in claim 1, wherein the carboxylate is sodium acetate or sodium benzoate.

10. The cleaning solution as claimed in claim 1, wherein the carboxylic acid, carboxylate, or a combination thereof has a concentration of about 150-200 g/L.

11. The cleaning solution as claimed in claim 1, further comprising nitric acid with a concentration of about 75-150 g/L.

12. The cleaning solution as claimed in claim 1, further comprising nitric acid with a concentration of about 100-125 g/L.

13. A method for cleaning stainless steel, comprising:
providing a cleaning solution, the solution comprising: one or more ingredients selecting from a group consisting of inorganic acid, inorganic alkali metal salt, and inorganic alkaline-earth metal salt in a concentration of about 200-600 g/L; complexant being capable of complexing with ferric or ferrous ions in a concentration of about 26-275 g/L; and one of carboxylic acid and carboxylate, or a combination thereof, in a concentration of about 75-250 g/L; and
contacting the stainless steel with the cleaning solution.

14. The method as claimed in claim 13, wherein the contacting lasts for about 15-120 seconds at room temperature.

15. The method as claimed in claim 13, wherein the inorganic acid is phosphoric acid or sulphuric acid.

16. The method as claimed in claim 13, wherein the inorganic alkali metal salt is sodium phosphate or sodium sulfate.

17. The method as claimed in claim 13, wherein the inorganic alkaline-earth metal salt is magnesium sulfate or calcium sulfate.

18. The method as claimed in claim 13, wherein the complexant is one or more ingredients selected from a group consisting of disodium edentate dehydrate, tetrasodium salt dihydrate, etidronic acid, citric acid, sodium citrate, tartaric acid, sodium potassium tartrate, and sodium gluconate.

19. The method as claimed in claim 13, wherein the carboxylic acid is benzoic acid or carboxylic acid.

20. The method as claimed in claim 13, wherein the carboxylate is sodium acetate or sodium benzoate.
